(19) United States
(12) Patent Application Publication
(10) Pub. No.: US 2022/0343245 A1
(43) Pub. Date: Oct. 27, 2022

(54) Operating Method for Electronic Apparatus for Offering Information Related to Order and Electronic Apparatus Supporting Thereof

(71) Applicant: Coupang Corp., Seoul (KR)

(72) Inventors: Wei Wei, Seoul (KR); Kai Zhang, Seoul (KR); Guangyao Zhang, Seoul (KR); Soo Kyung Choi, Seoul (KR); Timothy Wolfgang Schoenharl, Seoul (KR)

(73) Assignee: Coupang Corp., Seoul (KR)

(21) Appl. No.: 17/406,705

(22) Filed: Aug. 19, 2021

(30) Foreign Application Priority Data
Apr. 26, 2021 (KR) 10-2021-0053716

(51) Int. Cl. G06Q 10/06; G06Q 10/08; G06Q 30/02

(52) U.S. Cl. CPC G06Q 10/06315; G06Q 10/06313; G06Q 10/06312; G06Q 10/087; G06Q 30/0202; G06Q 30/0201; G06Q 30/0635

(57) ABSTRACT

Disclosed are a method and electronic apparatus for providing information related to an order. The method includes acquiring quantity information of an order item in a fulfillment center and information on a period related to order quantity calculation for the order item, confirming a reference date for the order quantity calculation and a reference period starting from the reference date based on the information on the period, determining estimated consumption information of the order item by the reference date and estimated demand information of the order item for the reference period, and providing information on an order quantity of the order item calculated based on the quantity information, the estimated consumption information, and the estimated demand information.

### RELATED APPLICATION INFORMATION

The present application claims priority to and the benefit of Korean Patent Application No. 10-2021-0053716 filed on Apr. 26, 2021, and is incorporated by reference herein in its entirety.

### TECHNICAL FIELD

The following description relates to a method and apparatus for providing information related to an order, and more particularly, to a method of calculating an order quantity of items and providing information on the calculated order quantity and an electronic apparatus for the method.

### DESCRIPTION OF THE RELATED ART

With the development of electronic technology, e-commerce has taken its place as a form of shopping. Customers can purchase items online without going to a shopping mall or a market in person, and the items purchased online are delivered to delivery addresses designated by the customers.

A logistics information management system for such an e-commerce service can operate a plurality of fulfillment centers and manage information on each of the fulfillment centers for more effective service provision. For example, when an order for items occurs, the logistics information management system may determine the fulfillment center which will process the order in consideration of characteristics of the order (e.g., a delivery address and inventory in the fulfillment centers) and allocate the order to the determined fulfillment center.

In this regard, documents of related art such as KR100932262B1 may be consulted.

### DISCLOSURE OF THE INVENTION

### Technical Goals

According to a method of the present disclosure, an electronic apparatus for providing information related to an order provides information on an order quantity, which is calculated by determining an amount of inventory of order items in a fulfillment center and an amount of consumption of and an amount of demand for the order items, to increase the convenience of managing the order items.

Technical goals of the present disclosure are not limited to those described above, and other technical goals which have not been described may be clearly understood by those of ordinary skill in the art from the following descriptions.

### Technical Solutions

Various example embodiments may provide an operating method of an electronic apparatus for providing information related to an order and an electronic apparatus which supports the operating method.

According to various example embodiments, a method of providing information related to an order by an electronic apparatus includes acquiring quantity information of an order item in a fulfillment center and information on a period related to order quantity calculation for the order item, confirming a reference date for the order quantity calculation and a reference period starting from the reference date based on the information on the period, determining estimated consumption information of the order item by the reference date and estimated demand information for the order item for the reference period, and providing information on an order quantity of the order item calculated based on the quantity information, the estimated consumption information, and the estimated demand information.

In an example embodiment, the quantity information may include information on a current amount of inventory of the order item in the fulfillment center and information on a scheduled warehousing quantity of the order item by the reference date according to existing orders for the order item.

In an example embodiment, the estimated consumption information may include information on sales volume estimated to be sold by the reference date among the current amount of inventory of the order item in the fulfillment center and information on an amount of disposal estimated to occur by the reference date among a current amount of inventory.

In an example embodiment, the estimated sales volume may be determined based on an existing sales history of the order item.

In an example embodiment, the estimated amount of disposal may include a quantity of the order item whose deadline for sale or expiration date passes by the reference date.

In an example embodiment, the estimated demand information may include information on an amount of consumer demand for the order item estimated for the reference period and information on an amount of demand for safety stock of the order item for the reference period.

In an example embodiment, the estimated amount of consumer demand may be determined based on a price of the order item.

In an example embodiment, the estimated amount of consumer demand may be determined based on an existing history of demand for the order item.

In an example embodiment, the estimated amount of consumer demand may be determined based on sales characteristic of the order item.

In an example embodiment, the sales characteristic may include a characteristic that the order item is sold during a specific period.

In an example embodiment, the sales characteristic may include a characteristic in which a discount is applied to a price of the order item.

In an example embodiment, the amount of demand for safety stock may be determined based on an existing history of demand for the order item.

In an example embodiment, the amount of demand for safety stock may be a preset value.

In an example embodiment, when an estimated amount of inventory, which is determined based on the quantity information and the estimated consumption information, on the reference date is larger than the estimated amount of consumer demand and a difference between the estimated amount of inventory and the estimated amount of consumer demand is smaller than or equal to a threshold value, the information on the amount of demand for safety stock may be included in the estimated demand information.

In an example embodiment, the order item may correspond to a specific storage type.

In an example embodiment, the order quantity of the order item may be calculated based on a first value obtained by adding the estimated amount of consumer demand for the order item for the reference period and the amount of demand for safety stock for the reference period, which are included in the estimated demand information, a second value obtained by adding a current amount of inventory of the order item and a scheduled warehousing quantity of the order item by the reference date, which are included in the quantity information, and a third value which is the larger value between sales volume of the order item estimated to be sold by the reference date and the amount of disposal of the order item estimated to occur by the reference date which are included in the estimated consumption information.

In an example embodiment, the order quantity of the order item may be calculated to be a larger one of 0 and a value obtained by subtracting a fifth value, which is a larger one of 0 and a fourth value obtained by subtracting the third value from the second value, from the first value.

According to various example embodiments, an electronic apparatus for providing information related to an order includes a processor and one or more memories configured to store one or more instructions. When the one or more instructions are executed, the one or more instructions may control the processor to perform operations of: acquiring quantity information of an order item in a fulfillment center and information on a period related to order quantity calculation for the order item, confirming a reference date for order quantity calculation and a reference period starting from the reference date based on the information on the period, determining estimated consumption information of the order item by the reference date and estimated demand information for the order item for the reference period, and providing information on an order quantity of the order item calculated based on the quantity information, the estimated consumption information, and the estimated demand information.

The above-described various example embodiments of the present disclosure are only some example embodiments of the present disclosure, and various example embodiments reflecting technical characteristics of the present disclosure may be derived and understood from the following detailed description by those of ordinary skill in the art.

### [Effects]

The present disclosure proposes a method for an electronic apparatus, which provides information related to an order, to provide information on an order quantity calculated by determining an amount of inventory of order items in a fulfillment center and an amount of consumption of and an amount of demand for order items. Accordingly, the present disclosure has technical effects in terms of easily managing an order quantity of order items.

Effects obtainable from the present disclosure are not limited to those described above, and other effects which have not been described will be clearly understood from the following description by those of ordinary skill in the art.

### BRIEF DESCRIPTION OF THE DRAWINGS

FIG. 1 is a diagram illustrating an order information management system which allows an operating method of an electronic apparatus for providing information related to an order to be implemented according to various example embodiments.

FIG. 2 is a diagram illustrating a configuration of a server device and a device interoperating with the server device according to various example embodiments.

FIG. 3 is a flowchart illustrating an operating method of an electronic apparatus for providing information related to an order according to various example embodiments.

FIGS. 4A and 4B are diagrams illustrating an example in which a server device 100 calculates an order quantity for a reference period starting from a specific reference date at a current time point according to various example embodiments.

FIG. 5 is a diagram illustrating an example in which the server device 100 outputs information on an order quantity according to various example embodiments.

### DETAILED DESCRIPTION FOR CARRYING OUT THE INVENTION

The following example embodiments are provided by combining components and features of the present disclosure in specific forms. The components or features may be considered optional unless explicitly stated otherwise. The components or features may be implemented without being combined with other components or features. Various example embodiments of the present disclosure may be provided by combining some of the components and features. The order of operations described in the various embodiments may be changed. Some components or features of an example embodiment may be included in another example embodiment or may be replaced with corresponding components or features of another example embodiment.

In the following description of drawings, procedures or operations that may obscure the gist of various example embodiments are not described, and procedures or operations apparent to those of ordinary skill in the art are not described either.

Throughout the specification, when a part is referred to as “comprising” or “including” a component, this indicates that the part may further include another component, and other components are not excluded unless particularly stated otherwise. Terms such as “part,” “-ed-or,” and “module,” used in the specification refer to a unit which performs at least one function or operation and may be implemented in hardware, software, or a combination of hardware and software. Also, “a” or “an,” “one,” “the,” and words similar thereto may be used to include both the singular and the plural unless indicated otherwise in the context of various example embodiments (particularly in the context of the claims) or the context clearly prevents such an interpretation.

Hereinafter, example embodiments of the present disclosure will be described in detail with reference to the accompanying drawings. The detailed description set forth herein in connection with the accompanying drawings is intended as a description of example embodiments of the present disclosure and is not intended to represent all embodiments.

Specific terms used in the various example embodiments are provided only to help understanding of the present disclosure, and use of the specific terms may be modified in a different form without departing from the technical spirit of the present disclosure.

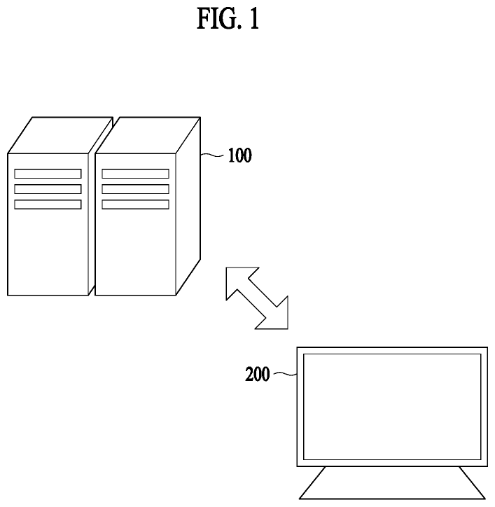

FIG. 1 is a diagram illustrating an order-related information providing system which allows an operating method of an electronic apparatus for providing information related to an order to be implemented according to various example embodiments.

Referring to FIG. 1, the order-related information providing system according to various example embodiments may be implemented as various types of electronic apparatus. For example, the order-related information providing system may be implemented in a server device 100 and a device 200 interoperating with the server device 100. In other words, the server device 100 and the device 200 interoperating with the server device 100 may perform operations according to various example embodiments of the present disclosure on the basis of the order-related information providing system implemented through the server device 100. Meanwhile, the order-related information providing system according to various example embodiments is not limited to that shown in FIG. 1 and may be implemented as a wider variety of electronic apparatus and servers.

The server device 100 according to various example embodiments may be an apparatus which performs wireless and wired communication with the device 200 interoperating with the server device 100 and includes a storage having a massive storage capacity. For example, the server device 100 may be a cloud device which is linked to a device interoperating with the server device 100.

The device 200 interoperating with the server device 100 according to various example embodiments may be an apparatus, such as a desktop personal computer (PC), a tablet PC, or a mobile terminal, which interoperates with the server device 100 to output information provided by the server device 100. In addition, other electronic apparatus which perform similar functions may be used as the device 200 interoperating with the server device 100.

The order-related information providing system according to various example embodiments may include various modules for operations. The modules included in the order-related information providing system may be a computer code or one or more instructions implemented so that a physical apparatus (e.g., the server device 100) in which the order-related information providing system is implemented (or included in the physical apparatus) can perform a designated operation. In other words, the physical apparatus in which the order-related information providing system is implemented may store a plurality of modules in a memory in the form of computer code, and when the plurality of modules stored in the memory are executed, the plurality of modules may cause the physical apparatus to perform designated operations corresponding to the plurality of modules.

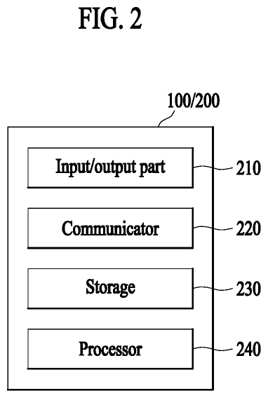

FIG. 2 is a diagram illustrating a configuration of a server device and a device interoperating with the server device according to various example embodiments.

Referring to FIG. 2, the server device 100 and the device 200 interoperating with the server device 100 may include an input/output part 210, a communicator 220, a storage 230, and a processor 240.

The input/output part 210 may be various types of interfaces or connection ports which receive a user input or output information to a user. The input/output part 210 may include an input module and an output module, and the input module receives a user input from a user. The user input may be made in various forms including a key input, a touch input, and a voice input. Examples of the input module receiving such a user input include not only a conventional keypad, keyboard, and mouse but also a touch sensor which senses the user's touch, a microphone which receives a voice signal, a camera which recognizes a gesture or the like through video recognition, a proximity sensor including at least one of an illumination sensor and an infrared sensor which senses the approach of the user, a motion sensor which recognizes the user's motion through an accelerometer, a gyro sensor, or the like, and various forms of input parts which sense or receive various other forms of user inputs. The input module according to the example embodiment of the present disclosure may include at least one of the aforementioned devices. Here, the touch sensor may be implemented as a touch panel which is attached to a display panel, a piezoelectric or capacitive touch sensor which detects a touch through a touch film, an optical touch sensor which detects a touch in an optical manner, or the like. Further, the input module may be implemented in the form of an input interface (a Universal Serial Bus (USB) port, a Personal System/2 (PS/2) port, or the like) which connects an external input device which receives a user input rather than a device for detecting a user input by itself. Also, the output module may output various kinds of information. The output module may include at least one of a display which outputs images, a speaker which outputs sound, a haptic device which generates vibrations, and various other forms of output parts. Further, the output module may be implemented in the form of a port-type output interface which is connected to the aforementioned individual output part.

For example, the output module in the form of a display may display text, still images, and videos. The display may include at least one of a liquid crystal display (LCD), a light-emitting diode (LED) display, an organic LED (OLED) display, a flat panel display (FPD), a transparent display, a curved display, a flexible display, a three-dimensional (3D) display, a holographic display, a projector, and various other forms of devices which may perform an image output function. Such a display may be in the form of a touch display integrated with the touch sensor of the input module.

The communicator 220 may communicate with another apparatus. Accordingly, the server device 100 and the device 200 interoperating with the server device 100 may exchange information with another apparatus through the communicator 220. For example, the server device 100 and the device 200 interoperating with the server device 100 may communicate with each other or another apparatus through the communicator 220.

Here, the communication, that is, transmission and reception of data, may be performed in a wired or wireless manner. To this end, the communicator 220 may be configured as a wired communication module which is connected to the Internet and the like through a local area network (LAN), a mobile communication module which is connected to a mobile communication network through a mobile communication base station and transmits and receives data, a short-range communication module which employs a wireless LAN (WLAN) communication method, such as Wi-Fi, or a wireless personal area network (WPAN) communication method, such as Bluetooth or ZigBee, a satellite communication module which employs a global navigation satellite system (GNSS), such as the Global Positioning System (GPS), or a combination thereof.

The storage 230 may store various kinds of information. The storage 230 may store data temporarily or semi-permanently. For example, the storage 230 of the server device 100 may store an operating system (OS) for running the server device 100, data for hosting a web site, data of a program or application (e.g., a web application) for generating braille, and the like. Also, the storage 230 may store modules in the form of computer code as described above.

Examples of the storage 230 may include a hard disk drive (HDD), a solid-state drive (SSD), a flash memory, a read-only memory (ROM), a random access memory (RAM), and the like. The storage 230 may be provided as an embedded type or a detachable type.

The processor 240 controls overall operations of the server device 100 and the device 200 interoperating with the server device 100. To this end, the processor 240 may compute and process various kinds of information and control operations of components of the server device 100. For example, the processor 240 may execute a program or application for providing information related to an order. The processor 240 may be implemented as a computer or a similar device according to hardware, software, or a combination thereof. The processor 240 may be implemented as hardware in the form of an electronic circuit which performs a control function by processing an electrical signal and may be implemented as software in the form of a program for operating the hardware processor 240. Meanwhile, unless there is a particular mention in the following description, operations of the server device 100 and the device 200 interoperating with the server device 100 may be understood as being performed under the control of the processor 240. In other words, when the modules implemented in the above-described order-related information providing system are executed, the processor 240 may be interpreted as controlling the modules to perform the following operations of the server device 100 and the device 200 interoperating with the server device 100.

In brief, various example embodiments may be implemented in various ways. For example, various example embodiments may be implemented by hardware, firmware, software, combinations thereof, or the like.

In the case of hardware implementation, a method according to various example embodiments may be implemented by one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of firmware or software implementation, a method according to various example embodiments may be implemented in the form of a module, a procedure, a function, and the like for performing functions or operations described below. For example, a software code may be stored in a memory and executed by the processor 240. The memory may be located inside or outside the processor 240 and may exchange data with the processor 240 in various well-known ways.

Various example embodiments will be described in further detail below on the basis of the above-described technical spirit. The above description may be applied to various example embodiments described below. For example, operations, functions, terms, etc. which are not defined in various example embodiments described below may be performed and described on the basis of the above description.

Various example embodiments are described below on the assumption that the server device 100 performs an operation of providing information related to an order. According to various example embodiments, the server device 100 or the device 200, which interoperates with the server device 100 and receives information related to an order from the server device 100, may output the information related to an order.

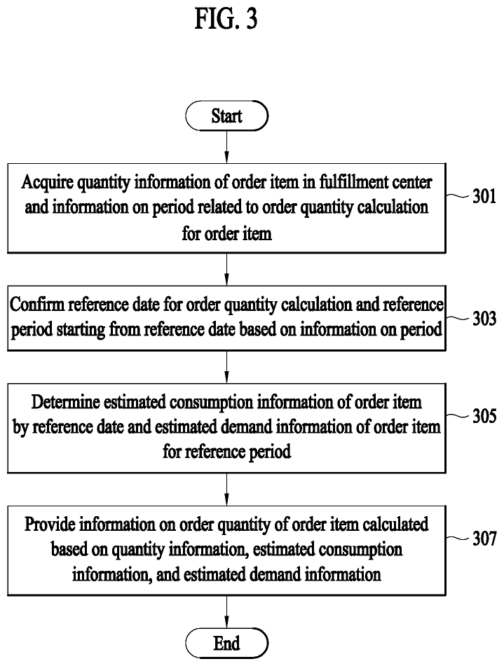

FIG. 3 is a flowchart illustrating an operating method of an electronic apparatus for providing information related to an order according to various example embodiments.

According to various example embodiments, in operation 301, the server device 100 may acquire quantity information of order items in a fulfillment center and information on a period related to order quantity calculation for order items. Here, the order items are items to be ordered. The fulfillment center may stock the items to be ordered in advance, and some of the items to be ordered may have been ordered already and be being delivered. In consideration of the items to be ordered which are stocked already and the items to be ordered which are being delivered, an order quantity of the items to be ordered may be calculated.

For example, the quantity information of order items in the fulfillment center may include information on a current amount of inventory of order items in the fulfillment center and information on a scheduled warehousing quantity of order items according to existing orders. Here, the current amount of inventory information of order items in the fulfillment center may be information on the quantity of order items that the fulfillment center has at the current time point. Also, the scheduled warehousing quantity of order items according to existing orders may be information on the quantity of order items which are being delivered after an order has already been placed or order information is provided to a supplier. Here, the scheduled warehousing quantity of order items according to existing orders may be confirmed differently depending on a reference date for counting a scheduled warehousing quantity. When the reference date is determined as a specific date, the server device 100 may acquire and confirm information on the quantity of order items to be stocked in the fulfillment center by the specific date according to the already placed order. As such, the scheduled warehousing quantity is intended to take a lead time, which is the period from the time of ordering to the time of delivery, into consideration, and an order quantity for placing a current order may be determined on the basis of the quantity of items which have been previously ordered and are scheduled to be delivered.

For example, the information on the period related to order quantity calculation may include information on a demand period for which an order quantity is calculated and a start point in time of the demand period. Here, the demand period for which an order quantity is calculated is a period for determining the amount of demand for order items to calculate an order quantity of order items and may be a reference period for order quantity calculation, and the start point in time is a start date of the reference period for order quantity calculation and may be a reference date. Meanwhile, the demand period may be set differently depending on example embodiments, and the definition of the demand period may be set differently according to a characteristic of the fulfillment center. In other words, the demand period may be adaptively set in consideration of a delivery procedure or stock situation of the fulfillment center.

For example, the server device 100 may determine the quantity of order items that the fulfillment center will have on a specific reference date or that the fulfillment center is estimated to have on the specific reference date on the basis of the acquired quantity information of order items in the fulfillment center and the acquired information on the period related to order quantity calculation for the order items. In other words, the server device 100 may confirm the reference date for order quantity calculation included in the information on the period related to order quantity calculation, confirm a current amount of inventory and a scheduled warehousing quantity of order items to be stocked in the fulfillment center by the reference date according to the already placed order, and determine first information including the quantity of order items that the fulfillment center will have on the specific reference date by adding the confirmed current amount of inventory and scheduled warehousing quantity.

Here, the first information, which is determined by the server device 100 on the basis of the quantity information of order items in the fulfillment center and the information on the period related to order quantity calculation for the order items, may correspond to the quantity of order items that the fulfillment center will have on the specific reference date on the basis of the current amount of inventory and the scheduled warehousing quantity according to the placed order when there is no additional consumption and warehousing quantity of order items between the current time point and the specific reference date.

For example, the order items for which the server device 100 acquires information according to operation 301 may be items corresponding to a specific storage type. Here, the items corresponding to the specific storage type may be items which require special management for a condition of temperature, humidity, light, or the like for the items because it is necessary to maintain the freshness or state of the items and of which the freshness or state is difficult to maintain when the items are not delivered within a short time. For example, the order items for which the server device 100 acquires information according to operation 301 may correspond to fresh food, and the specific storage type may be a type to be refrigerated. The order item may be fresh food which requires special management for a refrigeration temperature of the order item and delivery within a certain time because it is necessary to maintain the freshness or state of the order item. Meanwhile, a storage location in the fulfillment center may be set differently depending on storage types such as the above example. For example, the fulfillment center may separately have a room temperature storage area, a refrigerated storage area, and a freezer storage area. Accordingly, an item storage type of order items may be determined, and then an order quantity may be determined in consideration of an acceptable quantity in the storage area corresponding to the item storage type.

According to various example embodiments, in operation 303, the server device 100 may confirm the reference date and the reference period for order quantity calculation on the basis of the information on the period.

For example, the information on the period related to order quantity calculation may include information on a demand period for which an order quantity is calculated and a start point in time of the demand period. The demand period for which an order quantity is calculated is a period for determining the amount of demand for order items to calculate an order quantity of order items and may be a reference period for order quantity calculation, and the start point in time is a start date of the reference period for order quantity calculation. In other words, the server device 100 may acquire information on the reference date for calculating an order quantity of order items and the reference period starting from the reference date through operation 301 and confirm the information according to operation 303.

According to various example embodiments, in operation 305, the server device 100 may determine estimated consumption information for the order items by the reference date and estimated demand information for the order items for the reference period.

For example, the reference date and the reference period, which are criteria for the estimated consumption information and the estimated demand information determined by the server device 100 according to operation 305, may be the reference date and the reference period confirmed by the server device 100 according to operation 303.

For example, the estimated consumption information determined by the server device 100 according to operation 305 may include information on sales volume estimated to be sold by the reference date among the current amount of inventory of order items in the fulfillment center and information on the amount of disposal estimated to occur by the reference date among the current amount of inventory in the fulfillment center. Here, the information on the estimated sales volume may be the quantity of order items estimated to be sold from the current time point to the reference date, and the estimated value may be determined by the server device 100. Also, the information on the estimated amount of disposal may be the quantity of order items which are estimated to be disposed of from the current time point to the reference date.

Specifically, the information on the estimated sales volume may be determined on the basis of an existing sales history of the order items. Here, the existing sales history of the order items may be sales volume for a specific period in the past. The specific period for determining the existing sales history may be a preset period and may be set differently depending on a characteristic of the order items. For example, the specific period for determining the existing sales history may correspond to a period set to one week, one month, one quarter, or the like or may be set the same as a period previously set to determine a sales history of order items.

When the order items are sellable during a certain period due to the seasonality thereof, the specific period for determining the existing sales history may be set within the certain period in which the order items are sellable or may be set the same as a period previously set to determine a sales history of order items. When a discount is applied to the order items for a certain period, the specific period for determining the existing sales history may be set within the certain period in which the discount is applied or may be set the same as a period previously set to determine a sales history of order items to which a discount is applied.

Specifically, the information on the estimated amount of disposal may be determined in consideration of deadlines for sale or expiration dates of the order items. The deadlines for sale or the expiration dates may be time limits at which the order items become unavailable for sale because it is difficult to maintain the freshness or state of the order items. The deadlines for sale or the expiration dates may be set according to the characteristic of the order items. When the deadlines for sale or the expiration dates precede the reference date but the order items are not delivered until the reference date, the corresponding order items may be included in order items which are estimated to be disposed of. In other words, the information on the estimated amount of disposal may be the quantity of order items whose deadlines for sale or expiration dates pass by the reference date. Alternatively, the information on the estimated amount of disposal may be the quantity of order items which are estimated to be disposed of by the fulfillment center by the reference date for management reasons. In other words, the information on the estimated amount of disposal may be the quantity of order items which are estimated to become unavailable for sale by the reference date because it is difficult to maintain the state of the order items due to negligence of management of the fulfillment center and the like.

According to example embodiments, to confirm an estimated amount of disposal, information on deadlines for sale of current items in stock may be taken into consideration, and items whose deadlines for sale have passed may be disposed of. The deadlines for sale may be determined in consideration of the expiration dates, delivery period, and spare periods of the items. As an example, even when an item whose expiration date has not passed is delivered to a customer after a delivery period, a spare period in which the customer is expected to consume the item or which is set as an extra period may remain. In this case, the item may be considered as being sold. According to example embodiments, the deadlines for sale may be determined on the basis of some of the above elements, and in the case of the fulfillment center, delivery may be performed on a first-in first-out basis beginning with items whose deadlines for sale are imminent among items currently in stock. Accordingly, when an item whose deadline for sale is imminent is sold, the item may not be disposed of.

For example, the server device 100 may determine the quantity of order items which are consumed from the fulfillment center from the current time point to the specific reference date on the basis of the determined estimated consumption information and the acquired information on the period related to order quantity calculation. In other words, the server device 100 may confirm the reference date for order quantity calculation included in the information on the period related to order quantity calculation and determine second information including the quantity of order items consumed from the fulfillment center from the current time point to the reference date according to the determined estimated consumption information.

Here, the second information determined by the server device 100 on the basis of the estimated consumption information and the information on the period related to order quantity calculation may be used in determining an estimated amount of inventory in the fulfillment center on the specific reference date. As an example, the estimated amount of inventory in the fulfillment center on the specific date may be acquired by subtracting the second information from the first information determined by the server device 100 according to operation 301. The first information is the quantity of order items that the fulfillment center will have on the specific reference date and that is calculated by adding the current amount of inventory and the scheduled warehousing quantity, and the second information is the quantity of order items according to the sales volume and the amount of disposal of order items which are estimated to be consumed by the specific reference date among the current amount of inventory. Accordingly, the amount of inventory of order items that the fulfillment center is estimated to have on the specific reference date may be acquired by subtracting the second information from the first information.

For example, the estimated demand information determined by the server device 100 according to operation 305 may include information on estimated consumer demand for the order items for the reference period and information on the amount of demand for safety stock of the order items for the reference period. Here, the safety stock may be planned extra stock which is maintained to prevent shortage of supply due to demand that exceeds basic stock.

Specifically, the information on estimated consumer demand may be determined for the certain reference period on the basis of 1) the price of the order items, 2) an existing history of demand for the order items, 3) the sales characteristic of the order items, and the like.

The price of the order items may be a price at which the order items are sold to the customer. The existing history of demand for the order items may be a quantity demanded or sales volume during a specific period in the past, and the specific period for determining the existing history of demand may be a preset period. For example, the specific period for determining the existing history of demand may correspond to a period set to one week, one month, one quarter, or the like or may be set the same as a period previously set to determine the history of demand for the order items.

The sales characteristic of the order items may be the characteristic of the order items which is connected with sales of the order items and affects a quantity demanded. For example, when the order items have seasonality, the amount of demand for the order items may be determined only for a certain period in which the order items may be sold. When a discount is applied to the order items, the amount of demand for the order items may be determined only for a certain period in which the discount may be applied.

Specifically, the information on the amount of demand for safety stock may be determined on the basis of the existing history of demand for the order items. In other words, the amount of demand for safety stock is determined according to the amount of demand exceeding the basic inventory and thus may be determined on the basis of the existing history of demand for the order items. The specific period for determining the existing history of demand may correspond to a period set to one week, one month, one quarter, or the like or may be set the same as a period previously set to determine the history of demand for the order items. Alternatively, the information on the amount of demand for safety stock may not be flexibly determined on the basis of the existing history of demand for the order items and may be determined to have a preset value. As an example, the preset value may be set to the amount of demand exceeding a previous case in which the highest excess demand has been present. In this case, the amount of demand for safety stock is less likely to be higher than the amount of excess demand, and thus the server device 100 may determine the preset value as information on the amount of demand for safety stock as described above.

For example, the information on the amount of demand for safety stock may be included in the estimated demand information determined by the server device 100 according to operation 305 only when a certain condition is satisfied. As an example, the estimated amount of inventory in the fulfillment center on the reference date determined on the basis of the quantity information and the estimated consumption information according to operation 301 to operation 305 may be larger than the estimated amount of consumer demand determined according to operation 305. In this case, the information on the amount of demand for safety stock may be included in the estimated demand information only when a difference between the estimated amount of inventory and the estimated amount of consumer demand is within a threshold value.

When the estimated amount of consumer demand is smaller than the estimated amount of inventory in the fulfillment center on the specific reference date, it is basically unnecessary to order the items. However, when there is an amount of demand for safety stock, whether to place an order may vary depending on the amount of demand for safety stock. As an example, when the sum of the estimated amount of consumer demand and the amount of demand for safety stock is smaller than the estimated amount of inventory in the fulfillment center on the specific reference date, it is still unnecessary to order the items. However, when the sum of the estimated amount of consumer demand and the amount of demand for safety stock is larger than the estimated amount of inventory in the fulfillment center on the specific reference date, it may be necessary to order the items.

When the estimated amount of consumer demand is smaller than the estimated amount of inventory in the fulfillment center on the specific reference date and there is a large difference therebetween, it is necessary to order the items due to the amount of demand for safety stock, and there is a high possibility that the order items of the corresponding order will not be sold. Here, the amount of demand for safety stock is taken into consideration only when the difference between the estimated amount of inventory in the fulfillment center on the specific reference date and the estimated amount of consumer demand is within the certain threshold value. In this case, even when it is necessary to order the items due to the amount of demand for safety stock, the possibility that the order items of the corresponding order will be sold may be higher than the possibility that the order items will not be sold. Accordingly, when the estimated amount of consumer demand is smaller than the estimated amount of inventory in the fulfillment center, the server device 100 may include the information on the amount of demand for safety stock in the estimated demand information as long as the difference therebetween is within the threshold value.

For example, the server device 100 may determine the quantity of order items that the fulfillment center should have for the reference period on the basis of the information on the determined estimated consumption and the acquired information on the period related to order quantity calculation for the order items. In other words, the server device 100 may confirm the reference period for order quantity calculation included in the information on the period related to order quantity calculation and determine third information including the quantity of order items that the fulfillment center should have in order to meet the demand for the reference period according to the information on the determined estimated consumption.

Here, the third information determined by the server device 100 on the basis of the estimated demand information and the information on the period related to order quantity calculation may be used in calculating an order quantity necessary for the fulfillment center. As an example, the server device 100 may acquire an estimated amount of inventory in the fulfillment center on the specific reference date through the first information and the second information determined according to operations 301 to 305 and acquire the necessary order quantity by subtracting the estimated amount of inventory from the quantity of order items that the fulfillment center should have and which is included in the third information.

According to various example embodiments, in operation 307, the server device 100 may provide information on the order quantity of order items which is calculated on the basis of the quantity information, the estimated consumption information, and the estimated demand information.

For example, the order quantity of order items may be calculated on the basis of a first value obtained by adding the estimated amount of consumer demand for the order items for the reference period and the amount of demand for safety stock for the reference period, which are included in the estimated demand information, a second value obtained by adding the current amount of inventory of order items and the scheduled warehousing quantity of order items by the reference date, which are included in the quantity information, and a third value which is the larger value between the sales volume of order items estimated to be sold by the reference date and the amount of disposal of order items estimated to occur by the reference date which are included in the estimated consumption information. Here, the larger value between the estimated sales volume and the estimated amount of disposal is used as the third value to reflect that the order items correspond to a specific storage type. In other words, when the order items correspond to a specific storage type, items that the fulfillment center has may be delivered for sale in increasing order of deadline for sale or expiration date. Accordingly, the larger value between information on the estimated sales volume and information on the estimated amount of disposal included in the estimated consumption information may be used in order quantity calculation. Also, the estimated demand may be determined in consideration of at least one of the characteristic of the order items, information related to when the order items are sold, and discount information for the order items.

For example, the order quantity of order items may be calculated to be the larger one of 0 and a value obtained by subtracting a fifth value, which is the larger one of 0 and a fourth value obtained by subtracting the third value from the second value, from the first value.

The third value is subtracted from the second value to acquire an estimated amount of inventory in the fulfillment center on the reference date. Since the estimated amount of inventory is not smaller than 0, the larger one of 0 and the fourth value obtained by subtracting the third value from the second value is determined as the fifth value which is the estimated amount of inventory in the fulfillment center. Also, the fifth value is subtracted from the first value to acquire the necessary order quantity by subtracting the estimated amount of inventory in the fulfillment center from the amount of demand for the reference period starting from the reference date. Since the necessary order quantity is not smaller than 0, the larger one of 0 and the value obtained by subtracting the fifth value from the first value is determined as the necessary order quantity value.

When these are put together, an equation for calculating an order quantity for the reference period starting from the specific reference date according to operation 307 may be defined as follows.

Order quantity=Max([Amount of consumer demand estimated for reference period+Amount of demand for safety stock for reference period−Max({Amount of inventory at current time point+Warehousing quantity scheduled from current time point to reference date according to existing orders−Max(Sales volume estimated from current time point to reference date, Amount of disposal estimated from current time point to reference date)},0)],0) [Equation 1]

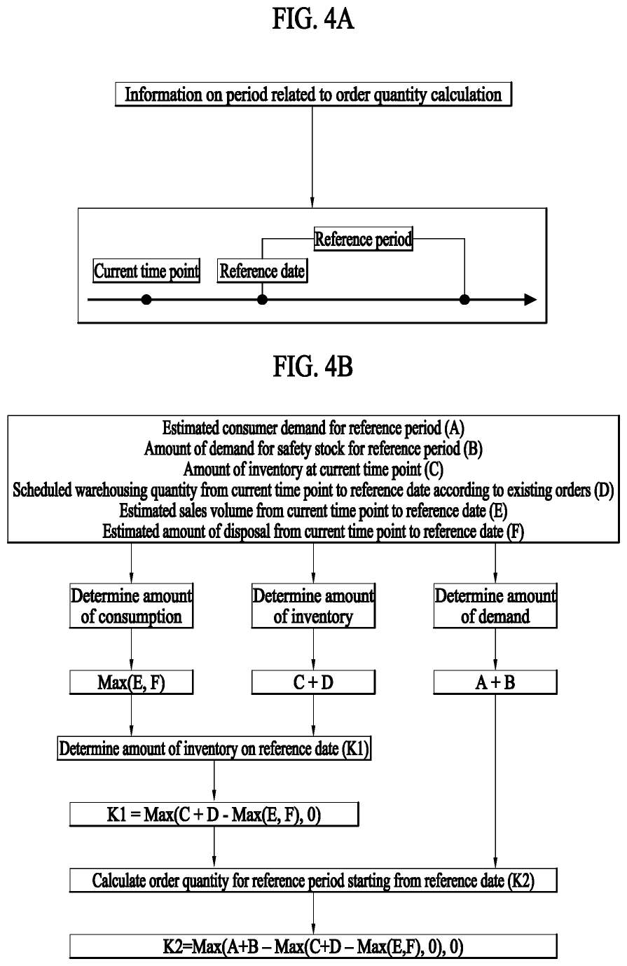

FIGS. 4A and 4B are diagrams illustrating an example in which the server device 100 calculates an order quantity for a reference period starting from a specific reference date at the current time point according to various example embodiments. The server device 100 may perform a procedure as shown in the sequence diagram of FIGS. 4A and 4B on the basis of various kinds of information which are acquired or determined to calculate an order quantity.

Referring to FIG. 4A, the server device 100 may acquire information on a period related to order quantity calculation at the current time point to confirm a reference date for order quantity calculation and a reference period starting from the reference date.

Referring to FIG. 4B, for order quantity calculation, the server device 100 may acquire, confirm, or determine information A on the amount of consumer demand estimated for the reference period, information B on the amount of demand for safety stock for the reference period, information C on the amount of inventory at the current time point, information D on a warehousing quantity scheduled from the current time point to the reference date according to existing orders, information E on sales volume estimated from the current time point to the reference date, and information F on the amount of disposal estimated from the current time point to the reference date.

To determine the amount of consumption of order items from the current time point to the reference date, the larger one of the estimated sales volume E and the estimated amount of disposal F may be acquired. Here, the larger value between the estimated sales volume and the estimated amount of disposal is used to reflect that the order items correspond to a specific storage type. In other words, when the order items correspond to a specific storage type, items that the fulfillment center has may be delivered for sale in increasing order of deadline for sale or expiration date. Accordingly, the larger value between the estimated sales volume and the estimated amount of disposal may be determined as the amount of consumption of order items from the current time point to the reference date.

Also, to determine the amount of inventory of order items in the fulfillment center on the reference date, the sum of the current amount of inventory C and the scheduled warehousing quantity D according to existing orders may be acquired, and to determine the amount of demand for the reference period, the sum of the estimated amount of consumer demand A and the amount of demand for safety stock B may be acquired.

To determine the estimated amount of inventory of order items on the reference date, the server device 100 may acquire a larger value K1 between 0 and a value obtained by subtracting the larger one of the estimated sales volume E and the estimated amount of disposal F from the sum of the current amount of inventory C and the scheduled warehousing quantity D according to existing orders. Here, the larger one of the subtraction result and 0 is used to reflect that the estimated amount of inventory on the reference date is not a negative value.

To calculate an order quantity for the reference period, the server device 100 may acquire a larger value K2 between 0 and a value obtained by subtracting the estimated amount of inventory from the sum of the amount of consumer demand A and the amount of demand for safety stock B. Here, the larger one of 0 and the subtraction result is used to reflect that an order quantity calculated for the reference period is not a negative value.

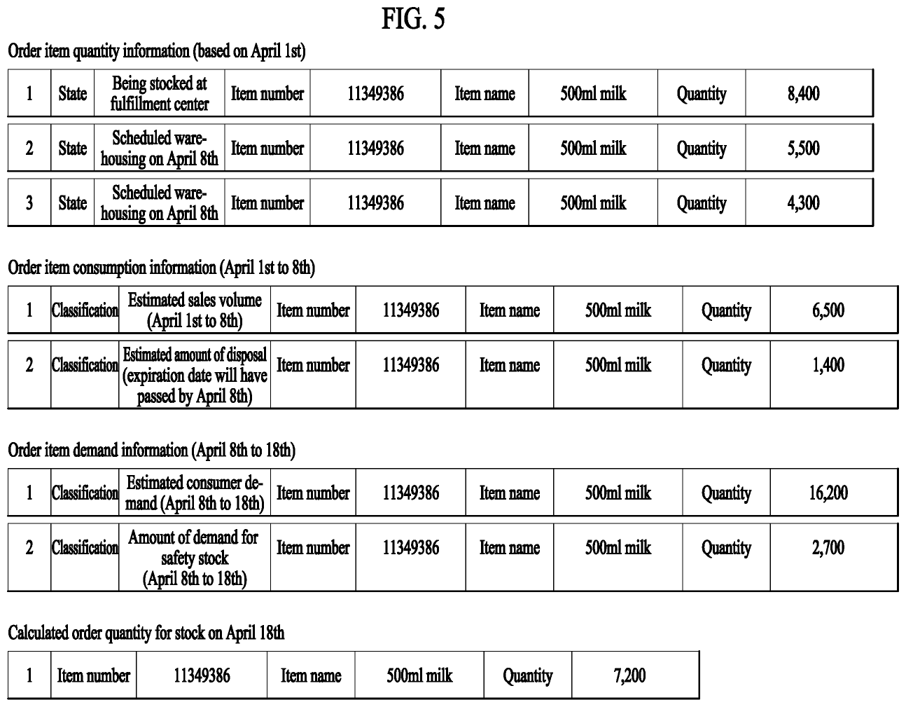

FIG. 5 is a diagram illustrating an example in which the server device 100 outputs information on an order quantity according to various example embodiments. For example, the example of FIG. 5 may be order information output through a user interface (Up/user experience (UX) for the server device 100 or the device 200 interoperating with the server device 100, and each of example embodiments described with reference to the drawing may be performed on the basis of the operations of the server device 100 described above with reference to FIGS. 3, 4A, and 4B. However, each of the example embodiments described with reference to FIG. 5 is not limited to such a form and may be performed in any form of implementing order information output through the UI/UX for the server device 100 or the device 200 interoperating with the server device 100.

FIG. 5 is a diagram showing an example in which the server device 100 or the device 200 interoperating with the server device 100 outputs order quantity information calculated on the basis of operations of the server device 100 according to various example embodiments.

Referring to FIG. 5, the server device 100 confirms and outputs quantity information of order items for a fulfillment center on the basis of April 1St which is the current time point. According to the quantity information, the quantity of “500 ml milk” that the fulfillment center has on April 1St which is the current time point is 8,400, and the quantity of “500 ml milk” which is scheduled for warehousing by a reference date of April 8^{th}is 9,800 that is the sum of 5,500 and 4,300.

The server device 100 determines and outputs estimated consumption information including an estimated sales volume and an estimated amount of disposal for the period from April 1^{st} to April 8^{th} corresponding to the period from the current time point to the reference date. According to the consumption information, sales volume of items estimated from April 1^{st} to April 8^{th}is 6,500, and the amount of disposal of items estimated by April 8^{th}is 1,400. Also, the server device 100 determines and outputs demand information including an estimated amount of consumer demand and an amount of demand for safety stock for the period from April 8^{th}to April 18^{th}which is a reference period. According to the demand information, from April 8^{th}to April 18th, an estimated amount of consumer demand for items is 16,200, and an estimated amount of demand for safety stock is 2,700.

The server device 100 of FIG. 5 may calculate an order quantity on the basis of the order quantity calculation method proposed through FIGS. 3, 4A, and 4B according to the following equation.

Order quantity=Max([Amount of consumer demand estimated for reference period(16,200)+Amount of demand for safety stock for reference period(2,700)−Max({Amount of inventory at current time point(8,400)+Warehousing quantity scheduled from current time point to reference date according to existing orders(9,800)−Max(Sales volume estimated from current time point to reference date(6,500),Amount of disposal estimated from current time point to reference date(1,400)))},0)]=7,200 [Equation 2]

In this way, the server device 100 may output the order quantity information of 7,200 calculated for order items.

The operation of outputting order quantity information through the UI/UX for the server device 100 or the device 200 interoperating with the server device 100 in FIG. 5 may be performed in connection with the operations of the server device 100 described above with reference to FIGS. 3, 4A, and 4B. The UI/UX of FIG. 5 is an example for illustrating the present disclosure. Various example embodiments of the present disclosure are not limited to the UI/UX of FIG. 5 and may be performed according to any type of UI/UX for implementing the example embodiments of the present disclosure.

The example embodiments of the present disclosure described with reference to the specification and the drawings are merely illustrative of specific examples to easily describe the technical content of the present disclosure and aid in understanding the present disclosure and are not intended to limit the scope of the present disclosure. In other words, it will be apparent to those of ordinary skill in the art that other modifications based on the technical spirit of the present disclosure are feasible. Also, the example embodiments may be combined with each other as necessary. For example, parts of all the example embodiments of the present disclosure may be combined with each other and implemented by a system.

Also, the method according to the present disclosure can be implemented in the form of program instructions which may be executed through various computing parts and recorded on a computer-readable medium.

As such, the various example embodiments of the present disclosure can be implemented as a computer-readable code on a computer-readable recording medium. The computer-readable recording medium may be any data storage device which can store data readable by a computer system. Examples of the computer-readable recording medium may include ROMs, RAMs, compact disc (CD)-ROMs, magnetic tapes, floppy disks, optical data storage devices, and carrier waves (data transmission over the Internet and the like). The computer-readable recording medium may be distributed over computer systems connected to a network so that the computer-readable code is stored and executed in a distributed manner. Further, functional programs, code, and code segments for achieving the various example embodiments of the present disclosure may be easily construed by programmers skilled in the field to which the present disclosure is applied.

The apparatus and method according to the various example embodiments of the present disclosure can be implemented in the form of hardware, software, or a combination of hardware and software. Such software may be recorded in volatile or non-volatile storage devices, such as ROMs, memories, such as RAMs, memory chips, memory devices, or integrated circuits, or machine (e.g., computer)-readable storage media which are optically or magnetically recordable, such as CDs, digital versatile discs (DVDs), magnetic disks, or magnetic tapes. The method according to various example embodiments of the present disclosure may be implemented by a computer or a portable terminal including a controller and a memory, a vehicle including such a memory or computer, and the like. The memory may be an example of a machine-readable storage medium which is appropriate for storing a program or programs containing instructions for implementing the example embodiments of the present disclosure.

Accordingly, the present disclosure encompasses a program containing code for implementing the apparatus or method set forth in the claims of the specification and a machine (computer or the like)-readable storage medium storing the program. The program may be electronically transferred through any media, such as communication signals transmitted through a wired or wireless connection, and the present disclosure properly includes the equivalents thereof.

Although the present disclosure has been described above with reference to the example embodiments, the example embodiments disclosed in the specification and drawings are merely presented to easily describe technical content of the present disclosure and help understanding of the present disclosure and are not intended to limit the scope of the present disclosure. Also, the above-described example embodiments of the present disclosure are merely exemplary, and those of ordinary skill in the art would understand that various modifications and equivalents can be made from the example embodiments. Therefore, the technical scope of the present disclosure should be defined by the following claims.

What is claimed is:

1. A method of providing information related to an order by an electronic apparatus, the method comprising:
acquiring quantity information of an order item in a fulfillment center and information on a period related to order quantity calculation for the order item;
confirming a reference date for the order quantity calculation and a reference period starting from the reference date based on the information on the period;
determining estimated consumption information of the order item by the reference date and estimated demand information of the order item for the reference period; and
providing information on an order quantity of the order item calculated based on the quantity information, the estimated consumption information, and the estimated demand information.

2. The method of claim 1, wherein the quantity information includes information on a current amount of inventory of the order item in the fulfillment center and information on a scheduled warehousing quantity by the reference date according to existing orders for the order item.

3. The method of claim 1, wherein the estimated consumption information includes information on sales volume estimated to be sold by the reference date among a current amount of inventory of the order item in the fulfillment center and information on an amount of disposal estimated to occur by the reference date among the current amount of inventory.

4. The method of claim 3, wherein the estimated sales volume is determined based on an existing sales history of the order item.

5. The method of claim 3, wherein the estimated amount of disposal includes a quantity of the order item whose deadline for sale or expiration date passes by the reference date.

6. The method of claim 1, wherein the estimated demand information includes information on an amount of consumer demand for the order item estimated for the reference period and information on an amount of demand for safety stock of the order item for the reference period.

7. The method of claim 6, wherein the estimated amount of consumer demand is determined based on a price of the order item.

8. The method of claim 6, wherein the estimated amount of consumer demand is determined based on an existing history of demand for the order item.

9. The method of claim 6, wherein the estimated amount of consumer demand is determined based on sales characteristic of the order item.

10. The method of claim 9, wherein the sales characteristic includes a characteristic that the order item is sold during a specific period.

11. The method of claim 9, wherein the sales characteristic includes a characteristic in which a discount is applied to a price of the order item.

12. The method of claim 6, wherein the amount of demand for safety stock is determined based on an existing history of demand for the order item.

13. The method of claim 6, wherein the amount of demand for safety stock is a preset value.

14. The method of claim 6, wherein when an estimated amount of inventory, which is determined based on the quantity information and the estimated consumption information, on the reference date is larger than the estimated amount of consumer demand and a difference between the estimated amount of inventory and the estimated amount of consumer demand is smaller than or equal to a threshold value, the information on the amount of demand for safety stock is included in the estimated demand information.

15. The method of claim 1, wherein the order item corresponds to a specific storage type.

16. The method of claim 1, wherein the order quantity of the order item is calculated based on:
a first value obtained by adding an estimated amount of consumer demand for the order item for the reference period and an amount of demand for safety stock for the reference period which are included in the estimated demand information;
a second value obtained by adding a current amount of inventory of the order item and a scheduled warehousing quantity by the reference date which are included in the quantity information; and
a third value which is a larger value between sales volume of the order item estimated to be sold by the reference date and an amount of disposal of the order item estimated to occur by the reference date which are included in the estimated consumption information.

17. The method of claim 16, wherein the order quantity of the order item is calculated to be a larger one of 0 and a value obtained by subtracting a fifth value, which is a larger one of 0 and a fourth value obtained by subtracting the third value from the second value, from the first value.

18. An electronic apparatus for providing information related to an order, the electronic apparatus comprising:
a processor; and
one or more memories configured to store one or more instructions,
wherein when the one or more instructions are executed, the one or more instructions control the processor to perform operations of:
acquiring quantity information of an order item in a fulfillment center and information on a period related to order quantity calculation for the order item;
confirming a reference date for the order quantity calculation and a reference period starting from the reference date based on the information on the period;
determining estimated consumption information of the order item by the reference date and estimated demand information of the order item for the reference period; and
providing information on an order quantity of the order item calculated based on the quantity information, the estimated consumption information, and the estimated demand information.
